(19) United States
(12) Patent Application Publication
(10) Pub. No.: US 2024/0223447 A1
(43) Pub. Date: Jul. 4, 2024

(54) SYSTEMS AND METHODS FOR PROVISIONING NETWORK SLICES

(71) Applicant: Verizon Patent and Licensing Inc., Basking Ridge, NJ (US)

(72) Inventors: Bharadwaj VEMURI, Jersey City, NJ (US); Lily ZHU, Parsippany, NJ (US); Balaji L. RAGHAVACHARI, Bridgewater, NJ (US); Brian T. MECUM, Aliso Diejo, CA (US)

(73) Assignee: Verizon Patent and Licensing Inc., Basking Ridge, NJ (US)

(21) Appl. No.: 18/148,238

(22) Filed: Dec. 29, 2022

(51) Int. Cl. H04L 41/0806; G06F 9/54; H04L 9/40; H04L 67/141

(52) U.S. Cl. CPC H04L 41/0806; G06F 9/547; H04L 63/08; H04L 67/141

(57) ABSTRACT

In some implementations, a network device may receive, from a cloud computing service, an indication associating a connection identifier with a network slice identifier. The network device may store the indication. The network device may receive, from a network operator, a request including the connection identifier. Accordingly, the network device may transmit, to the network operator, the network slice identifier in response to the request.

### BACKGROUND

Network slicing is a network architecture design technique that allows for customization of network functions to specific applications or groups of applications. An operating system of a user device may request a network slice when establishing a connection for an application.

### BRIEF DESCRIPTION OF THE DRAWINGS

FIGS. 1A-IC are diagrams of an example associated with provisioning network slices.

FIG. 2 is a diagram of an example associated with provisioning network slices using machine learning.

FIG. 3 is a diagram of an example associated with provisioning network slices.

FIG. 4 is a diagram of an example associated with updating network slices.

FIG. 5 is a diagram of an example environment in which systems and/or methods described herein may be implemented.

FIG. 6 is a diagram of example components of one or more devices of FIG. 5.

FIG. 7 is a flowchart of an example process associated with provisioning network slices.

### DETAILED DESCRIPTION OF EXAMPLE EMBODIMENTS

The following detailed description of example implementations refers to the accompanying drawings. The same reference numbers in different drawings may identify the same or similar elements.

When a user device executes an application programmed to transmit data to, and/or receive data from, a remote server, the user device may request a connection to the remote server via a network. For example, the network may be a wireless cellular network, such as a fifth generation (5G) next generation (NG) network or a long term evolution (LTE) network, among other examples. Alternatively, the network may be a non-cellular wired, wireless, or optical network, such as an Ethernet network or a WiFi® network, among other examples. The remote server may be hosted using a cloud service and support the application by exchanging data via the network.

In order to improve user experience, the network may provision a network slice for the application to use when exchanging data with the remote server. For example, the network slice may include a set of dedicated network functions in a core network and may sometimes include at least one network function that is shared with at least one other network slice. The network slice may provide technical improvements for the application. For example, the network slice may reduce latency when the application is delay-sensitive (e.g., when the application is a virtual reality (VR) application or an augmented reality (AR) application, among other examples). In another example, the network slice may increase throughput when the application is data-heavy (e.g., when the application buffers multimedia or is associated with file transfers, among other examples).

Generally, to provision a network slice, the network receives a request, from a modem of the user device, as generated by an operating system (OS) that supports the application. Because each OS vendor uses a different set of network slice identifiers, memory overhead is consumed at the network to store all of the identifiers across OS vendors. Additionally, in order to deploy a new service (e.g., a new cloud service) associated with a new network slice, a new identifier for the new network slice is generated for each OS vendor, which wastes processing resources and memory overhead at the network.

By exchanging traffic information between a cloud service and a network operator, network slicing may be provisioned across OSs without using different identifiers associated with different OS vendors. Some implementations described herein enable a network device to receive network slicing information from the cloud service and provide the network slicing information to the network operator. As a result, the network operator provisions network slices for user devices based on the network slicing information from the network device, which improves user experience (e.g., by reducing latency or increasing throughput, among other examples). Additionally, the network operator conserves memory as compared with storing all network slice identifiers across OS vendors. The cloud service may also deploy a new service and inform the network operator via the network device, which conserves processing resources and memory at the network operator as compared with generating a new network slice identifier for each OS vendor.

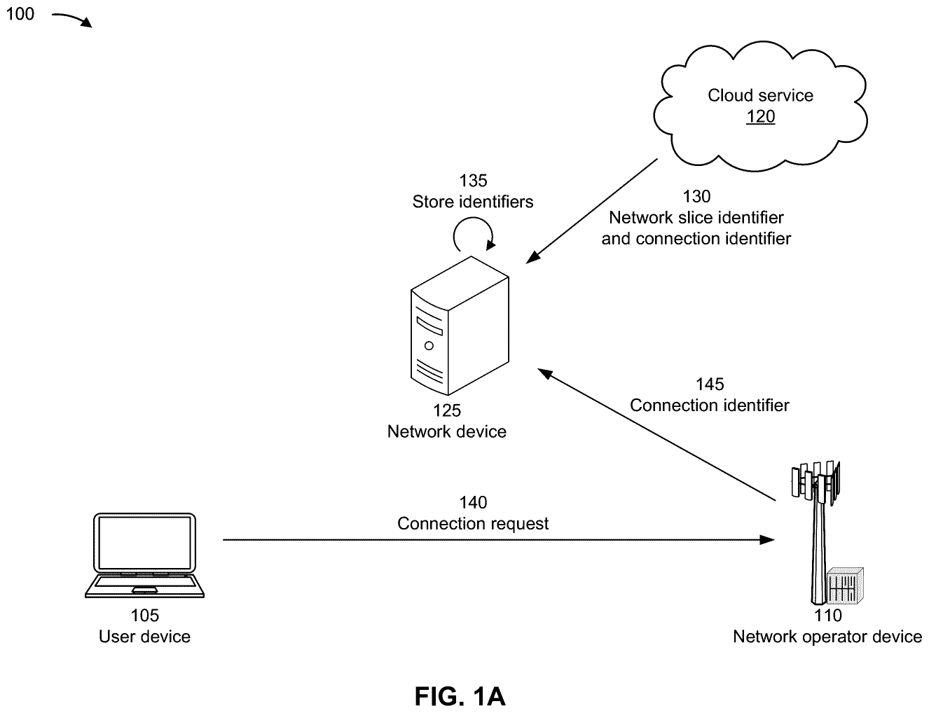

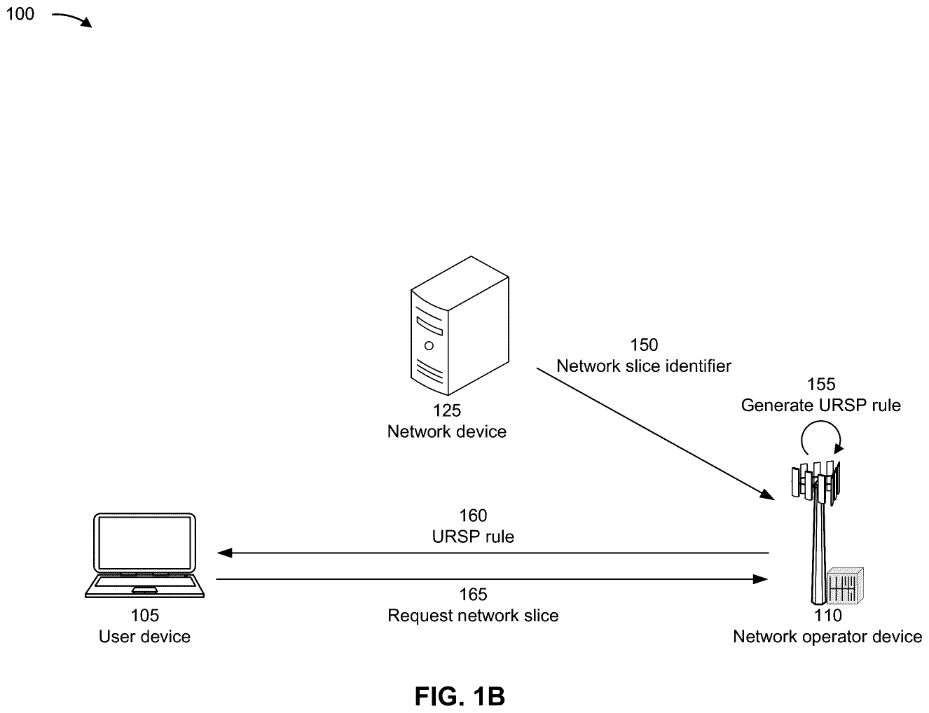

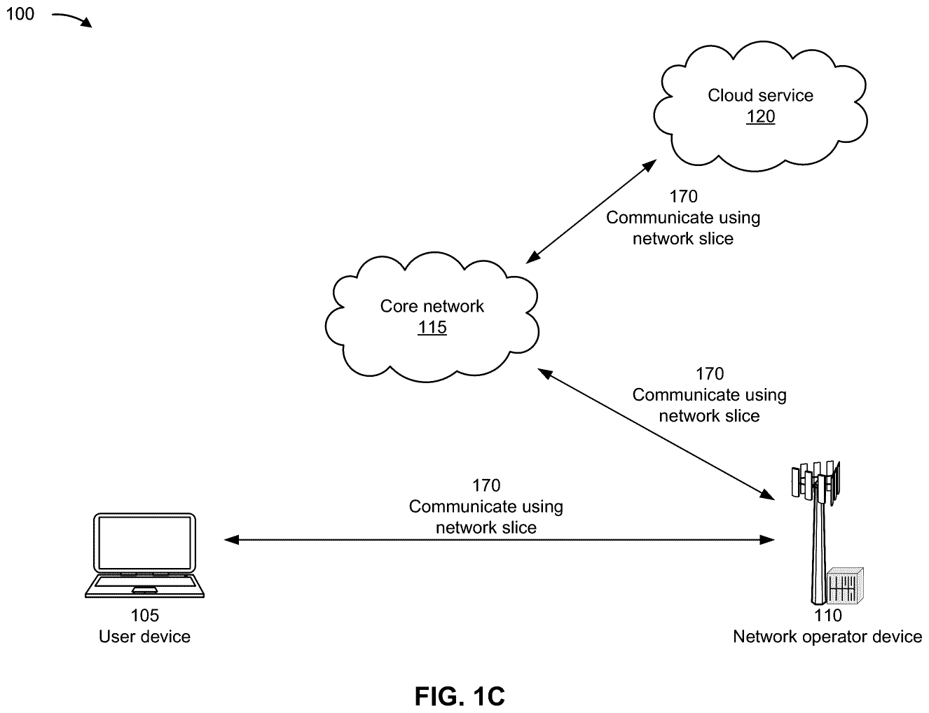

FIGS. 1A-1C are diagrams of an example 100 associated with provisioning network slices. As shown in FIGS. 1A-1C, example 100 includes a user device 105, a network operator device 110 (also referred to as a “network operator”), a core network 115, a cloud service 120 (also referred to as a “cloud computing service”), and a network device 125.

As shown in FIG. 1A and by reference number 130, the cloud service 120 may transmit, and the network device 125 may receive, an indication associating a connection identifier with a network slice identifier. The connection identifier may include a device type indicator, an Internet protocol (IP) address, and/or a port number. The cloud service 120 may provide a service associated with the connection identifier. For example, the cloud service 120 may accept data from, and/or provide data to, an application executed by an end user (e.g., using the user device 105). Accordingly, the connection identifier may be an endpoint associated with an application programming interface (API) or another type of endpoint for the application.

The network slice identifier may include a traffic category indicator and/or single network slice selection assistance information (S-NSSAI). For example, the cloud service 120 may indicate that a service, provided over a connection associated with the connection identifier, is associated with a low-latency traffic category. In another example, the cloud service 120 may indicate that a service, provided over a connection associated with the connection identifier, is associated with a high-throughput traffic category.

Additionally, or alternatively, the cloud service 120 may indicate a particular network slice (e.g., using S-NSSAI) to use for a connection associated with the connection identifier. For example, the cloud service 120 may receive S-NSSAIs (e.g., directly from network operators and/or via the network device 125) and determine to assign the S-NSSAIs to connection identifiers (e.g., by mapping traffic categories associated with the S-NSSAIs to traffic categories associated with the connection identifiers).

In some implementations, the cloud service 120 may transmit, and the network device 125 may receive, a set of credentials. For example, the set of credentials may include a username and password, biometric information, a token, a certificate signature, and/or another type of information for authenticating the cloud service 120. Accordingly, the network device 125 may verify the set of credentials and accept the indication associating the connection identifier with the network slice identifier based on verifying the set of credentials. For example, the cloud service 120 may provide the set of credentials with an API call or another type of request such that the network device 125 processes a body of the request (e.g., including the indication) based on verifying the set of credentials. In another example, the cloud service 120 may provide the set of credentials such that the network device 125 establishes a secure connection with the cloud service 120 based on verifying the set of the credentials; accordingly, the cloud service 120 may transmit, and the network device 125 may receive, the indication using the secure connection.

In some implementations, the network device 125 may transmit, and the cloud service 120 may receive, a request for updates. Accordingly, the cloud service 120 may transmit the indication associating the connection identifier with the network slice identifier in response to the request for updates. The request may be transmitted periodically (e.g., according to a schedule stored at the network device 125) and/or on-demand (e.g., when an administrator operating the network device 125 inputs a trigger to transmit the requests). Additionally, or alternatively, the cloud service 120 may transmit a push communication to the network device 125 including the indication associating the connection identifier with the network slice identifier. For example, the network device 125 may subscribe to updates from the cloud service 120 (e.g., by transmitting a request for an API subscription) such that the cloud service 120 transmits, without request, the push communication (e.g., via the API) whenever a new association between a connection identifier and a network slice identifier is available.

In some implementations, the connection identifier may be associated with a new service established at the cloud service 120. For example, the cloud service 120 may establish the new service to support a new application. In another example, the cloud service 120 may establish the new service to support a new functionality of an existing application. In yet another example, the cloud service 120 may establish the new service to replace an outdated service for an existing application. Accordingly, the cloud service 120 may transmit the indication (e.g., in a push communication, as described above) based on establishing the new service and determining the network slice identifier to associate with the connection identifier of the new service.

As shown by reference number 135, the network device 125 may store the connection identifier in association with the network slice identifier (e.g., by storing the indication received from the cloud service 120). For example, the network device 125 may transmit the identifiers to a storage associated with the network device 125. The storage may be local to the network device 125. Alternatively, the storage may be at least partially separate (e.g., physically, logically, and/or virtually) from the network device 125. Accordingly, the network device 125 may transmit a request including the identifiers to an external device managing the storage (e.g., by calling an API associated with the storage and including the identifiers as arguments). The network device 125 may store the connection identifier and the network slice identifier in a relational database or another type of data structure that associates the connection identifier with the network slice identifier.

As shown by reference number 140, the user device 105 may transmit, and the network operator device 110 may receive, a connection request. For example, a modem of the user device 105 may transmit the connection request based on a command from an OS of the user device 105, generated in response to a request from an application executed by the user device 105 and supported by the OS. The connection request may include the connection identifier. For example, the connection request may indicate an endpoint (e.g., using an IP address or another type of endpoint indicator) included in the connection identifier. In some implementations, the connection request may additionally indicate a port number included in the connection identifier. Additionally, or alternatively, the connection request may additionally indicate a device type associated with the user device 105 and included in the connection identifier.

Accordingly, as shown by reference number 145, the network operator device 110 may transmit, and the network device 125 may receive, a request for network slice information associated with the connection identifier. The request for network slice information may include the connection identifier. For example, the network operator device 110 may extract the connection identifier from the connection request from the user device 105 and re-encode the connection identifier into the request for network slice information intended for the network device 125. The request for network slice information may therefore include an IP address, a port number, a device type associated with the user device 105, and/or another type of identifier associated with a connection with the cloud service 120 that is being requested by the user device 105.

In some implementations, the network operator device 110 may transmit, and the network device 125 may receive, a set of credentials. For example, the set of credentials may include a username and password, biometric information, a token, a certificate signature, and/or another type of information for authenticating the network operator device 110. Accordingly, the network device 125 may verify the set of credentials and accept the request for network slice information based on verifying the set of credentials. For example, the network operator device 110 may provide the set of credentials with an API call or another type of request such that the network device 125 processes a body of the request (e.g., including the connection identifier) based on verifying the set of credentials. In another example, the network operator device 110 may provide the set of credentials such that the network device 125 establishes a secure connection with the network operator device 110 based on verifying the set of the credentials; accordingly, the network operator device 110 may transmit, and the network device 125 may receive, the request for network slice information using the secure connection.

Based on the request for network slice information, the network device 125 may determine the network slice identifier associated with the connection identifier included in the request. For example, the network device 125 may query the storage using the connection identifier included in the request and receive the associated network slice identifier in response to the query. Therefore, as shown in FIG. 1B and by reference number 150, the network device 125 may transmit, and the network operator device 110 may receive, the network slice identifier in response to the request for network slice information. For example, the network device 125 may include the network slice identifier in a response to an API call from the network operator device 110 that included the request for network slice information.

The network operator device 110 may thus provision a network slice (e.g., to the user device 105) based on the network slice identifier. For example, the network operator device 110 may establish a connection for the user device 105 (e.g., for the application executed by the user device 105 that initiated the connection request) to the cloud service 120 through the network slice (e.g., implemented by the core network 115). One example of provisioning the network slice is shown in FIGS. 1B and 1C.

As shown in FIG. 1B and by reference number 155, the network operator device 110 may generate a user equipment route selection policy (URSP) rule (e.g., at least one URSP rule) based on the network slice identifier. For example, the network operator device 110 may generate the URSP rule such that the connection request from the user device 105 is routed through a network slice associated with the network slice identifier indicated by the network device 125.

Alternatively, the network operator device 110 may retrieve the URSP rule (e.g., from a local storage associated with the network operator device 110 or a storage at least partially separate from the network operator device 110). For example, the network operator device 110 may query the storage using the network slice identifier from the network device 125 in order to receive the URSP rule. The URSP rule may route traffic (e.g., from the user device 105) through a network slice associated with the network slice identifier indicated by the network device 125.

As shown by reference number 160, the network operator device 110 may transmit, and the user device 105 may receive, the URSP rule. Accordingly, as shown by reference number 165, the user device 105 may transmit, and the network operator device 110 may receive, a request for the network slice consistent with the URSP rule. For example, the URSP rule may indicate S-NSSAI, a data network name (DNN), and/or session and service continuity (SSC) mode information. Therefore, the user device 105 may request the network slice using the S-NSSAI, the DNN, and/or the SSC mode information in order to connect to the cloud service 120 using the network slice.

As shown in FIG. 1C and by reference number 170, the network operator device 110 may connect the user device 105 to the cloud service 120 via the network slice as implemented at the core network 115. For example, the network slice may include at least an initial network function that interfaces with the network operator device 110 and a final network function that interfaces with the cloud service 120. The network slice may additionally include one or more network functions between the initial network function and the final network function. The network slice may include a set of dedicated network functions in a core network and may sometimes include at least one network function that is shared with at least one other network slice. Using the network slice, the user device 105 may communicate with the cloud service 120 with improved speed, improved throughput, and/or another type of improvement (e.g., depending on properties of the network slice).

By using techniques as described in connection with FIGS. 1A-1C, the network device 125 facilitates network slice information transfer between the cloud service 120 and the network operator device 110. As a result, network slicing may be provisioned for the user device 105 regardless of the OS executed by the user device 105. Thus, the user device 105 uses a network slice that improves user experience (e.g., by reducing latency or increasing throughput, among other examples). Additionally, the network operator device 110 conserves memory as compared with storing all network slice identifiers across OS vendors. Furthermore, the cloud service 120 may deploy a new service and inform the network operator device 110 via the network device 125, which conserves processing resources and memory at the network operator device 110 as compared with generating a new network slice identifier for each OS vendor.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

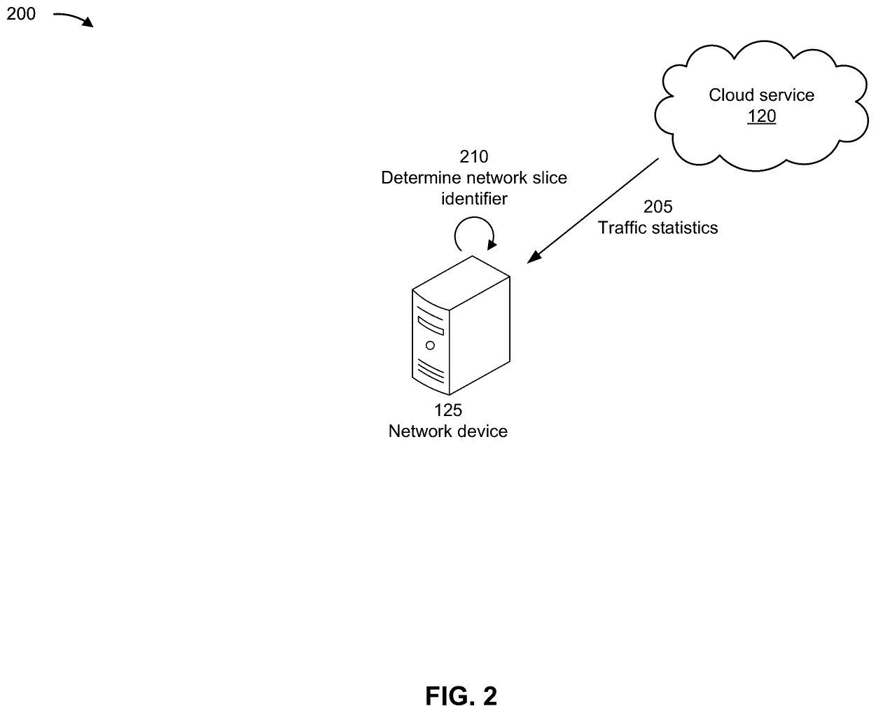

FIG. 2 is a diagram of an example 200 associated with provisioning network slices using machine learning. As shown in FIG. 2, example 200 includes a cloud service 120 and a network device 125.

Example 200 is similar to example 100; however, as shown by reference number 205, the cloud service 120 may transmit, and the network device 125 may receive, traffic statistics in addition to, or in lieu of, an indication associating a connection identifier with a network slice identifier. For example, the cloud service 120 may indicate an average volume of traffic, a burst rate, an average latency per packet, an average ping rate, and/or another type of statistic associated with computer network traffic. The cloud service 120 may indicate the traffic statistics in association with an IP address, a port number, a device type, and/or another type of connection identifier.

As shown by reference number 210, the network device 125 may determine a network slice identifier to be associated with the connection identifier based on the traffic statistics. In some implementations, the network device 125 may apply rules (e.g., one or more rules) to determine the network slice identifier. For example, the network device 125 may select a first network slice identifier when an average volume of traffic and/or a burst rate satisfy a traffic threshold, may select a second network slice identifier when an average latency and/or an average ping rate satisfy a latency threshold, and may select a third network slice identifier when both the traffic threshold and the latency threshold are satisfied. Other examples may use only the traffic threshold or the latency threshold. Alternatively, other examples may use one or more additional thresholds (e.g., related to throughput and/or another connection property).

Additionally, or alternatively, the network device 125 may apply a machine learning model to the traffic statistics to determine the network slice identifier. For example, the machine learning model may accept statistics associated with computer network traffic as input and may output a recommended network slice identifier (or may rank a plurality of network slice identifiers). The machine learning model may include a regression model, an artificial neural network (ANN), or another type of model trained to associate traffic statistics with network slice identifiers. The training may be supervised such that the machine learning model associates traffic statistics with network slice identifiers based on selected features extracted from training data. Alternatively, the training may be unsupervised such that the machine learning model independently selects the features from the training data. The machine learning model may include one or more hyperparameters that are tuned in order to (at least locally) minimize a loss function calculated based on the training data.

When the network device 125 has not received a network slice identifier associated with the connection identifier from the cloud service 120, the network device 125 may use the determined network slice identifier. When the network device 125 has received a different network slice identifier associated with the connection identifier from the cloud service 120, the network device 125 may transmit the determined network slice identifier to the cloud service 120 as a recommendation. The network device 125 may replace the received network slice identifier with the determined network slice in response to an approval of the recommendation received from the cloud service 120. Alternatively, the network device 125 may replace the received network slice identifier with the determined network slice unless a rejection of the recommendation is received from the cloud service 120 (e.g., within a preconfigured amount of time, such as before an expiry associated with the recommendation).

Accordingly, the network device 125 may generate, and store, an indication associating the connection identifier with the network slice identifier. For example, the network device 125 may transmit the indication to a storage associated with the network device 125. The storage may be local to the network device 125. Alternatively, the storage may be at least partially separate (e.g., physically, logically, and/or virtually) from the network device 125. Accordingly, the network device 125 may transmit a request including the indication to an external device managing the storage (e.g., by calling an API associated with the storage and including the identifiers as arguments). The network device 125 may encode the indication in a relational database or another type of data structure that associates the connection identifier with the network slice identifier.

The network device 125 may therefore use the indication when a network operator device 110 transmits a request including the connection identifier, as described in connection with FIG. 1B. By using techniques as described in connection with FIG. 2, the network device 125 may provide network slicing information to the network operator device 110, even when the cloud service 120 does not explicitly indicate which network slice to use. As a result, the network operator device 110 may provision a network slice for a user device 105 (e.g., as described in connection with FIGS. 1B and 1C), which improves user experience (e.g., by reducing latency or increasing throughput, among other examples). Additionally, the network operator device 110 conserves memory as compared with storing all network slice identifiers across OS vendors. The network device 125 may also determine which network slice to use for a new service from the cloud service 120, which conserves processing resources and memory at the network operator device 110, as compared with generating a new network slice identifier for each OS vendor.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

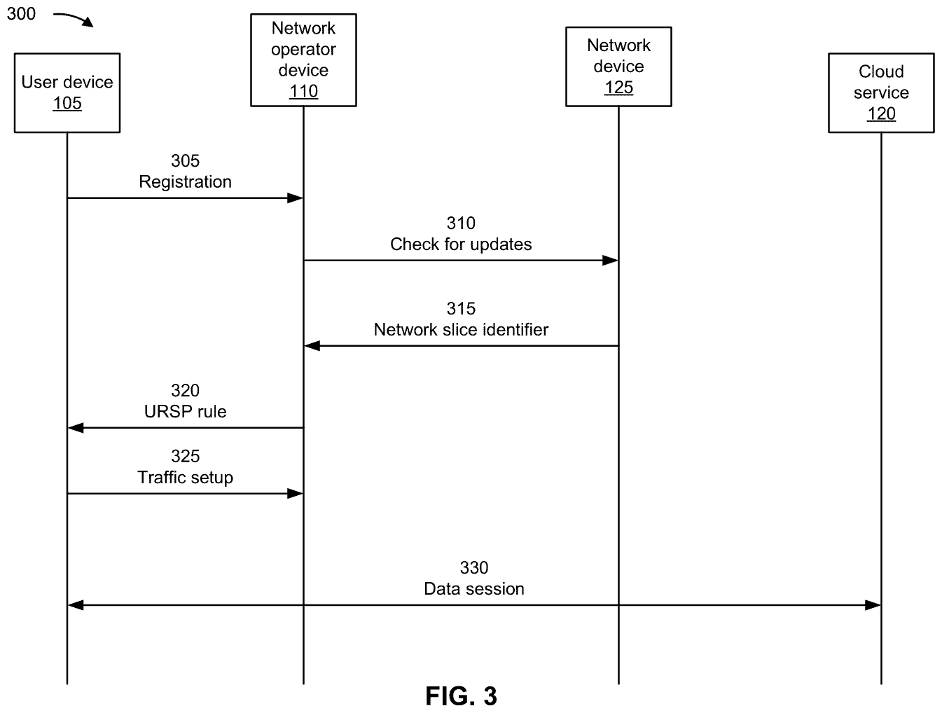

FIG. 3 is a diagram of an example 300 associated with provisioning network slices. As shown in FIG. 3, example 300 includes a user device 105, a network operator device 110, a cloud service 120, and a network device 125.

As shown by reference number 305, the user device 105 may transmit, and the network operator device 110 may receive, a registration message. For example, the user device 105 may transmit a non-access stratum (NAS) registration message to the network operator device 110 (e.g., for processing by a core network 115 supporting the network operator device 110). The NAS registration message may include a connection request associated with an application executed by the user device 105 (e.g., as described in connection with FIG. 1B).

Based on the NAS registration message, the network operator device 110 may determine to respond to the user device 105 with a URSP rule. In order to route traffic from the user device 105 more accurately, the network operator device 110 may transmit, and the network device 125 may receive, a request for updates, as shown by reference number 310. For example, the network operator device 110 may request any updates for network slicing to apply for a connection identifier included in the NAS registration message.

As shown by reference number 315, the network device 125 may transmit, and the network operator device 110 may receive, a network slice identifier to use. As described in connection with FIGS. 1A and 1B, the network slice identifier may include a device type indicator, an IP address, and/or a port number, among other examples.

Accordingly, as shown by reference number 320, the network operator device 110 may transmit, and the user device 105 may receive, the URSP rule based on the network slice identifier from the network device 125. The URSP rule may indicate S-NSSAI, a DNN, and/or SSC mode information such that the user device 105 may connect to the cloud service 120 using a network slice associated with the network slice identifier (e.g., as described in connection with FIG. 1B). As shown by reference number 325, the user device 105 may transmit, and the network operator device 110 may receive, a request for the network slice.

The network operator device 110 may establish a connection to the cloud service 120 through the network slice (e.g., as implemented in the core network 115, not shown in FIG. 3). Accordingly, the user device 105 may transmit data to, and/or receive data from, the cloud service 120 using a data session supported by the network slice, as shown by reference number 330. The network slice may provide improved speed, improved throughput, and/or another type of improvement (e.g., depending on properties of the network slice), as described in connection with FIG. 1C.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

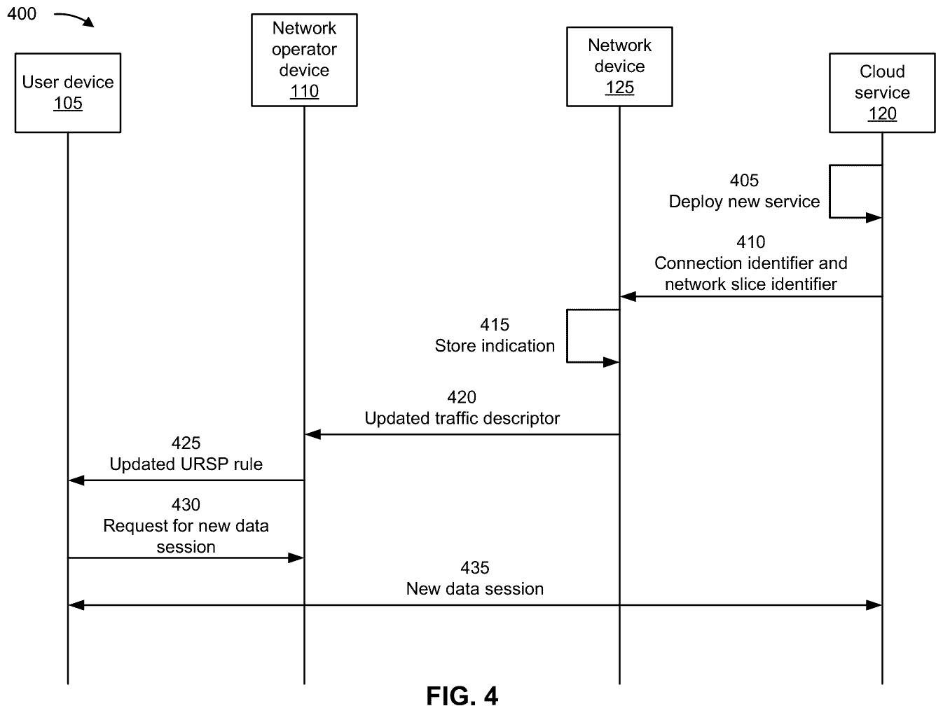

FIG. 4 is a diagram of an example 400 associated with updating network slices. As shown in FIG. 4, example 400 includes a user device 105, a network operator device 110, a cloud service 120, and a network device 125.

As shown by reference number 405, the cloud service 120 may deploy a new service. As described in connection with FIG. 1A, the cloud service 120 may establish the new service to support a new application, to support a new functionality of an existing application, or to replace an outdated service for an existing application. Accordingly, the cloud service 120 may determine a connection identifier to associate with the new service (e.g., a new IP address and/or a new port for an endpoint associated with the new service). Additionally, the cloud service 120 may determine a network slice identifier to associate with the new service. For example, the cloud service 120 may map a traffic category associated with the new service to a traffic category associated with the network slice identifier.

As shown by reference number 410, the cloud service 120 may transmit, and the network device 125 may receive, an indication associating the connection identifier with the network slice identifier. As described in connection with FIG. 1A, the network device 125 may transmit, and the cloud service 120 may receive, a request for updates; therefore, the cloud service 120 may transmit the indication associating the connection identifier with the network slice identifier in response to the request for updates. Additionally, or alternatively, the cloud service 120 may transmit a push communication to the network device 125 including the indication associating the connection identifier with the network slice identifier. For example, the network device 125 may subscribe to updates from the cloud service 120 (e.g., by transmitting a request for an API subscription) such that the cloud service 120 transmits, without request, the push communication (e.g., via the API) based on the new service being established.

As shown by reference number 415, the network device 125 may store the indication. As described in connection with FIG. 1A, the network device 125 may transmit the indication to a storage associated with the network device 125. The storage may be local to the network device 125. Alternatively, the storage may be at least partially separate (e.g., physically, logically, and/or virtually) from the network device 125. Accordingly, the network device 125 may transmit a request including the indication to an external device managing the storage (e.g., by calling an API associated with the storage and including the indication as an argument). The network device 125 may store the indication in a relational database or another type of data structure that associates the connection identifier with the network slice identifier.

Additionally, as shown by reference number 420, the network device 125 may transmit, and the network operator device 110 may receive, an updated traffic descriptor based on the indication. For example, the network operator device 110 may have established a connection for an application executed by the user device 105 that will use the new service. Accordingly, the network operator device 110 may receive the updated traffic descriptor in order to improve the connection for the application. Similarly to the network device 125, the network operator device 110 may transmit, and the network device 125 may receive, a request for updates; therefore, the network device 125 may transmit the updated traffic descriptor in response to the request for updates. Additionally, or alternatively, the network device 125 may transmit a push communication to the network operator device 110 including the updated traffic descriptor. For example, the network operator device 110 may subscribe to updates from the network device 125 (e.g., by transmitting a request for an API subscription) such that the network device 125 transmits, without request, the push communication (e.g., via the API) based on the new service being established.

Based on the updated traffic descriptor, the network operator device 110 may determine to transmit an updated URSP rule to the user device 105 rule in order to route traffic from the user device 105 to the new service. As shown by reference number 425, the network operator device 110 may transmit, and the user device 105 may receive, the updated URSP rule based on the updated traffic descriptor from the network device 125. The updated URSP rule may be included in a NAS message or another type of over-the-air (OTA) message. The URSP rule may indicate S-NSSAI, a DNN, and/or SSC mode information such that the user device 105 may connect to the new service provided by the cloud service 120 using a network slice associated with the network slice identifier (e.g., as described in connection with FIG. 1B). As shown by reference number 430, the user device 105 may transmit, and the network operator device 110 may receive, a request for a new data session on the network slice.

The network operator device 110 may establish a connection to the new service provided by the cloud service 120 through the network slice (e.g., as implemented in the core network 115, not shown in FIG. 4). Accordingly, the user device 105 may transmit data to, and/or receive data from, the new service provided by cloud service 120 using the new data session supported by the network slice, as shown by reference number 435. The network slice may provide improved speed, improved throughput, and/or another type of improvement (e.g., depending on properties of the network slice), as described in connection with FIG. 1C.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

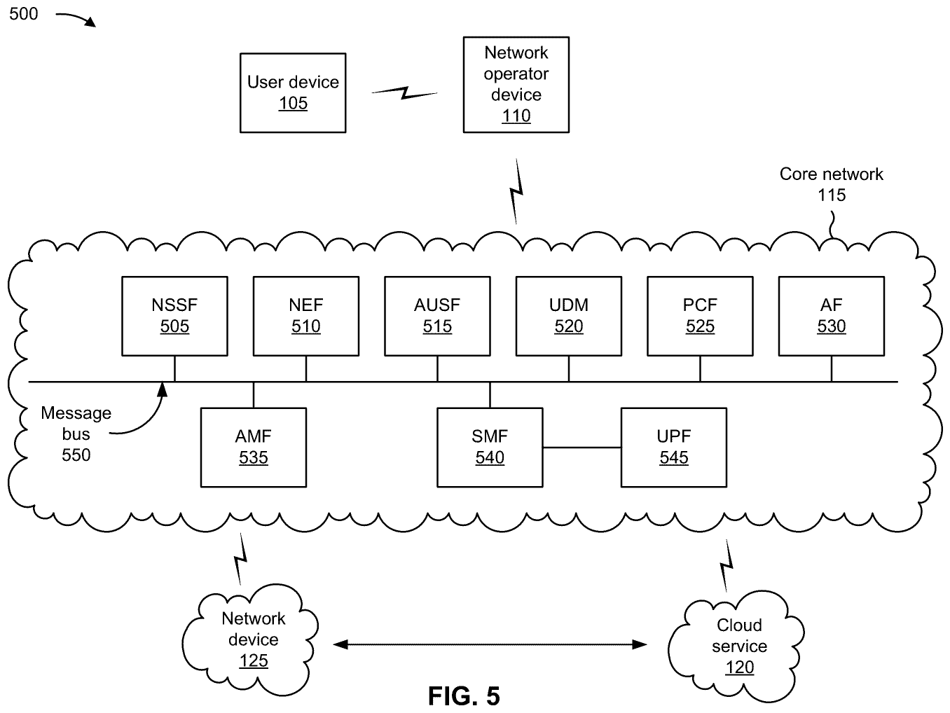

FIG. 5 is a diagram of an example environment 500 in which systems and/or methods described herein may be implemented. As shown in FIG. 5, example environment 500 may include a user device 105, a network operator device 110, a core network 115, a cloud service 120, and a network device 125. Devices and/or networks of example environment 500 may interconnect via wired connections, wireless connections, or a combination of wired and wireless connections.

The user device 105 includes one or more devices capable of receiving, generating, storing, processing, and/or providing information, such as information described herein. For example, the user device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The network operator device 110 may support, for example, a cellular radio access technology (RAT). The network operator device 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the user device 105. The network operator device 110 may transfer traffic between the user device 105 (e.g., using a cellular RAT), one or more base stations (e.g., using a wireless interface or a backhaul interface, such as a wired backhaul interface), and/or the core network 115. The network operator device 110 may provide one or more cells that cover geographic areas.

In some implementations, the network operator device 110 may perform scheduling and/or resource management for the user device 105 covered by the network operator device 110 (e.g., the user device 105 covered by a cell provided by the network operator device 110). In some implementations, the network operator device 110 may be controlled or coordinated by a network controller, which may perform load balancing, network-level configuration, and/or other operations. The network controller may communicate with the network operator device 110 via a wireless or wireline backhaul. In some implementations, the network operator device 110 may include a network controller, a self-organizing network (SON) module or component, or a similar module or component. In other words, the network operator device 110 may perform network control, scheduling, and/or network management functions (e.g., for uplink, downlink, and/or sidelink communications of the user device 105 covered by the network operator device 110).

In some implementations, the core network 115 may include an example functional architecture in which systems and/or methods described herein may be implemented. For example, the core network 115 may include an example architecture of a 5G NG core network included in a 5G wireless telecommunications system. While the example architecture of the core network 115 shown in FIG. 5 may be an example of a service-based architecture, in some implementations, the core network 115 may be implemented as a reference-point architecture and/or a fourth generation (4G) core network, among other examples.

As shown in FIG. 5, the core network 115 may include a number of functional elements. The functional elements may include, for example, a network slice selection function (NSSF) 505, a network exposure function (NEF) 510, an authentication server function (AUSF) 515, a unified data management (UDM) component 520, a policy control function (PCF) 525, an application function (AF) 530, an access and mobility management function (AMF) 535, a session management function (SMF) 540, and/or a user plane function (UPF) 545. These functional elements may be communicatively connected via a message bus 550. Each of the functional elements shown in FIG. 5 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 505 includes one or more devices that select network slice instances for the user device 105. By providing network slicing, the NSSF 505 allows an operator to deploy multiple substantially independent end-to-end networks potentially with the same infrastructure. In some implementations, each slice may be customized for different services.

The NEF 510 includes one or more devices that support exposure of capabilities and/or events in the wireless telecommunications system to help other entities in the wireless telecommunications system discover network services.

The AUSF 515 includes one or more devices that act as an authentication server and support the process of authenticating the user device 105 in the wireless telecommunications system.

The UDM 520 includes one or more devices that store user data and profiles in the wireless telecommunications system. The UDM 520 may be used for fixed access and/or mobile access in the core network 115.

The PCF 525 includes one or more devices that provide a policy framework that incorporates network slicing, roaming, packet processing, and/or mobility management, among other examples.

The AF 530 includes one or more devices that support application influence on traffic routing, access to the NEF 510, and/or policy control, among other examples.

The AMF 535 includes one or more devices that act as a termination point for NAS signaling and/or mobility management, among other examples.

The SMF 540 includes one or more devices that support the establishment, modification, and release of communication sessions in the wireless telecommunications system. For example, the SMF 540 may configure traffic steering policies at the UPF 545 and/or may enforce user equipment IP address allocation and policies, among other examples.

The UPF 545 includes one or more devices that serve as an anchor point for intraRAT and/or interRAT mobility. The UPF 545 may apply rules to packets, such as rules pertaining to packet routing, traffic reporting, and/or handling user plane quality of service (QoS), among other examples.

The message bus 550 represents a communication structure for communication among the functional elements. In other words, the message bus 550 may permit communication between two or more functional elements.

The cloud service 120 may include one or more devices capable of receiving, generating, storing, processing, and/or providing information associated with applications executed by the user device 105, as described elsewhere herein. The cloud service 120 may include a communication device and/or a computing device. For example, the cloud service 120 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device.

The network device 125 may include one or more devices capable of receiving, generating, storing, processing, and/or providing information associated with network slices, as described elsewhere herein. The network device 125 may include a communication device and/or a computing device. For example, the network device 125 may include a database, a server, a database server, an application server, a client server, a web server, a host server, a proxy server, a virtual server (e.g., executing on computing hardware), or a similar type of device. The network device 125 may communicate with the cloud service 120 (e.g., to receive connection identifiers and network slice identifiers) and with the network operator device 110 to indicate network slices (e.g., directly or, as shown in FIG. 5, via the core network 115).

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of example environment 500 may perform one or more functions described as being performed by another set of devices of example environment 500.

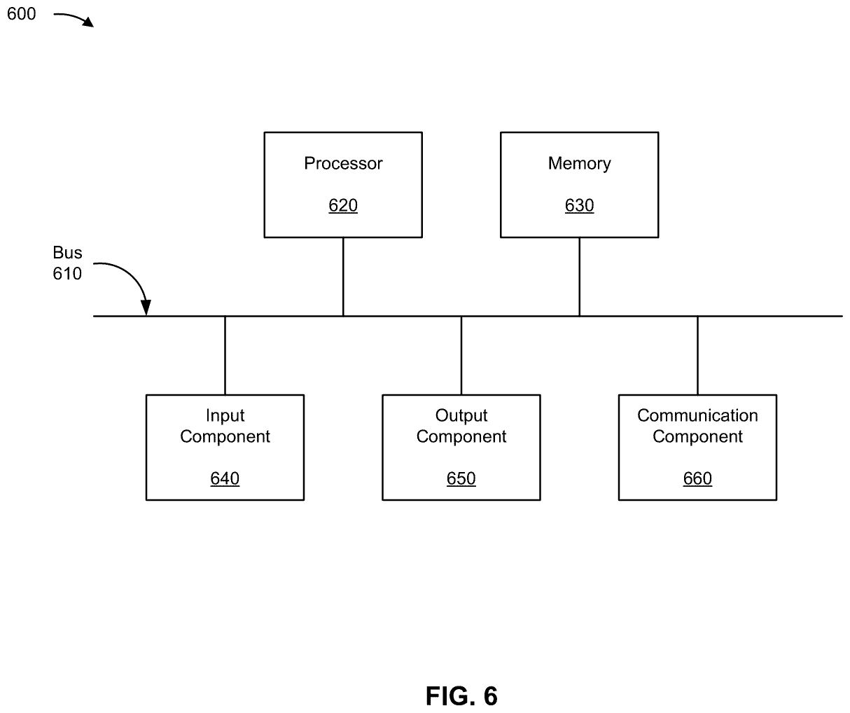

FIG. 6 is a diagram of example components of a device 600 associated with provisioning network slices. The device 600 may correspond to a user device 105, a network operator device 110, a core network 115, a cloud service 120, and/or a network device 125. In some implementations, the user device 105, the network operator device 110, the core network 115, the cloud service 120, and/or the network device 125 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

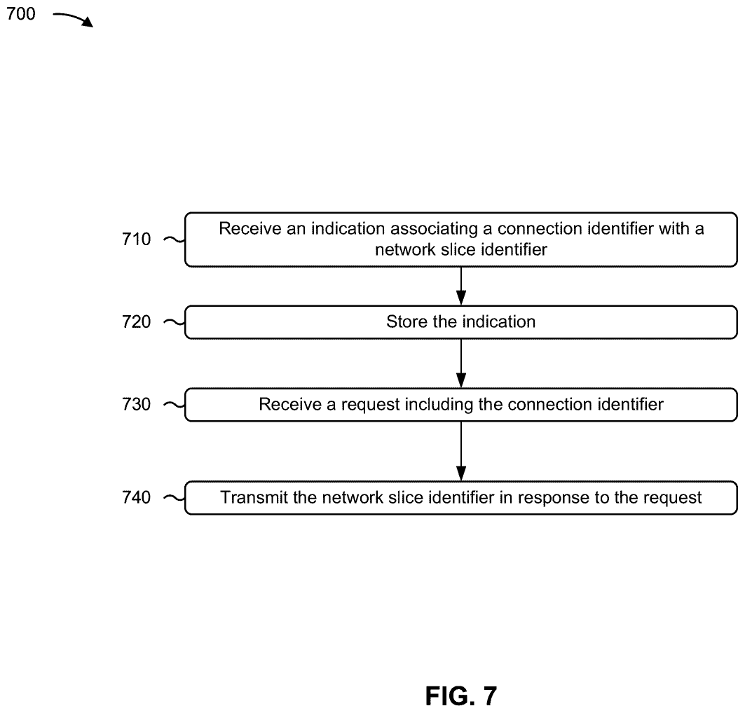

FIG. 7 is a flowchart of an example process 700 associated with provisioning network slices. In some implementations, one or more process blocks of FIG. 7 may be performed by a network device (e.g., network device 125). In some implementations, one or more process blocks of FIG. 7 may be performed by another device or a group of devices separate from or including the network device, such as a user device (e.g., user device 105), a network operator device (e.g., network operator device 110), a core network (e.g., core network 115), and/or a cloud service (e.g., cloud service 120). Additionally, or alternatively, one or more process blocks of FIG. 7 may be performed by one or more components of device 600, such as processor 620, memory 630, input component 640, output component 650, and/or communication component 660.

As shown in FIG. 7, process 700 may include receiving an indication associating a connection identifier with a network slice identifier (block 710). For example, the network device may receive (e.g., from a cloud computing service) an indication associating a connection identifier with a network slice identifier, as described herein. The connection identifier may include a device type indicator, an IP address, or a port. Additionally, or alternatively, the network slice identifier may include a traffic category indicator or S-NSSAI.

In some implementations, process 700 includes receiving (e.g., from the cloud computing service) a set of credentials, such that the indication is received based on verification of the set of credentials. Additionally, or alternatively, in some implementations, the network device may transmit (e.g., to the cloud computing service) a request for an API subscription, such that the indication is included in a push communication received by the network device based on the API subscription.

As further shown in FIG. 7, process 700 may include storing the indication (block 720). For example, the network device may store the indication, as described herein.

As further shown in FIG. 7, process 700 may include receiving a request including the connection identifier (block 730). For example, the network device may receive (e.g., from a network operator) a request including the connection identifier, as described herein. In some implementations, process 700 includes receiving (e.g., from the network operator) a set of credentials, such that the request is received based on verification of the set of credentials.

As further shown in FIG. 7, process 700 may include transmitting the network slice identifier in response to the request (block 740). For example, the network device may transmit (e.g., to the network operator) the network slice identifier in response to the request, as described herein.

In some implementations, as described in connection with FIG. 2, process 700 includes receiving (e.g., from the cloud computing service) traffic statistics associated with an additional connection identifier, applying a machine learning model to the traffic statistics to determine an additional network slice identifier, generating an additional indication associating the additional connection identifier with the additional network slice identifier, and storing the additional indication.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, from a cloud computing service, an indication associating a connection identifier with a network slice identifier;
storing, at a network device, the indication;
receiving, from a network operator, a request including the connection identifier; and
transmitting, to the network operator, the network slice identifier in response to the request.

2. The method of claim 1, further comprising:
receiving, from the cloud computing service, a set of credentials,
wherein the indication is received based on verification of the set of credentials.

3. The method of claim 1, wherein receiving the indication comprises:
transmitting, to the cloud computing service, a request for an application programming interface (API) subscription,
wherein the indication is included in a push communication received by the network device based on the API subscription.

4. The method of claim 1, further comprising:
receiving, from the network operator, a set of credentials,
wherein the request is received based on verification of the set of credentials.

5. The method of claim 1, wherein the connection identifier comprises a device type indicator, an Internet protocol (IP) address, or a port.

6. The method of claim 1, wherein the network slice identifier comprises a traffic category indicator or single network slice selection assistance information (S-NSSAI).

7. The method of claim 1, further comprising:
receiving, from the cloud computing service, traffic statistics associated with an additional connection identifier;
applying a machine learning model to the traffic statistics to determine an additional network slice identifier;
generating an additional indication associating the additional connection identifier with the additional network slice identifier; and
storing, at the network device, the additional indication.

8. A device, comprising:
one or more processors configured to:
receive, from a user device, a connection request including a connection identifier;
transmit, to a network device, a request for network slice information associated with the connection identifier;
receive, from the network device, a network slice identifier in response to the request; and
provision, to the user device, a network slice based on the network slice identifier.

9. The device of claim 8, wherein the one or more processors are further configured to:
transmit, to the user device, at least one user equipment route selection policy (URSP) rule,
wherein the network slice is provisioned based on the URSP rule.

10. The device of claim 9, wherein the one or more processors, to provision the network slice, are configured to:
receive, from the user device, a request for the network slice consistent with the URSP rule; and
connect the user device to an initial network function of the network slice in response to the request for the network slice.

11. The device of claim 8, wherein the one or more processors are further configured to:
transmit, to the network device, a set of credentials,
wherein the request for network slice information is transmitted based on the set of credentials.

12. The device of claim 8, wherein the connection identifier comprises a device type indicator, an Internet protocol (IP) address, or a port.

13. The device of claim 8, wherein the network slice identifier comprises a traffic category indicator or single network slice selection assistance information (S-NSSAI).

14. A non-transitory computer-readable medium storing a set of instructions, the set of instructions comprising:
one or more instructions that, when executed by one or more processors of a device, cause the device to:
establish a new service associated with a connection identifier;
determine a network slice identifier to associate with the connection identifier;
generate an indication associating the connection identifier with the network slice identifier; and
transmit, to a network device, the indication.

15. The non-transitory computer-readable medium of claim 14, wherein the one or more instructions, when executed by the one or more processors, further cause the device to:
receive, from the network device, a request for an application programming interface (API) subscription,
wherein the indication is transmitted based on the API subscription.

16. The non-transitory computer-readable medium of claim 14, wherein the one or more instructions, that cause the device to establish the new service, cause the device to:
establish a new Internet protocol (IP) address and port for the new service,
wherein the connection identifier is the IP address and the port.

17. The non-transitory computer-readable medium of claim 14, wherein the one or more instructions, that cause the device to determine the network slice identifier, cause the device to:
determine a traffic category associated with the new service,
wherein the network slice identifier corresponds to the traffic category.

18. The non-transitory computer-readable medium of claim 14, wherein the connection identifier comprises a device type indicator, an Internet protocol (IP) address, or a port.

19. The non-transitory computer-readable medium of claim 14, wherein the network slice identifier comprises a traffic category indicator or single network slice selection assistance information (S-NSSAI).

20. The non-transitory computer-readable medium of claim 14, wherein the one or more instructions, when executed by the one or more processors, further cause the device to:
transmit, to the network device, traffic statistics associated with an additional connection identifier.
